(19) United States
(12) Patent Application Publication
(10) Pub. No.: US 2021/0049707 A1
(43) Pub. Date: Feb. 18, 2021

(54) Personal Tax Advisor Service

(71) Applicant: Wells Fargo Bank, N.A., San Francisco, CA (US)

(72) Inventors: Gary F. Balding, Matthews, NC (US); Sharon B. Drawdy, Clyo, GA (US); Sunil Kothapalli, Marvin, NC (US); Adrienne Elizabeth Leo, Denver, NC (US); Danyall Lashon McDowell, Charlotte, NC (US); Daniel Sanford, Charlotte, NC (US); Brendon Hartman Treanor, Charlotte, NC (US)

(21) Appl. No.: 15/448,086

(22) Filed: Mar. 2, 2017

(51) Int. Cl. G06Q 40/00; G06Q 40/06

(52) U.S. Cl. CPC G06Q 40/123; G06Q 10/1093; G06Q 40/06

(57) ABSTRACT

A method for adjusting employee withholdings on an electronic computing device includes receiving a tax strategy from an individual. Initial tax information for the individual is obtained. An initial income tax amount to be paid by the individual is calculated. An initial tax withholding allowance is determined. When a notification of a tax event for the individual is received, tax information related to the tax event is automatically obtained. The tax information related to the tax event and the initial tax information is used to calculate a revised income tax amount. When a determination is made that the revised income tax amount is not consistent with the tax strategy, a revised tax withholding allowance is determined to comply with the tax strategy. When the revised tax withholding allowance is different than the initial tax withholding allowance, the revised tax withholding allowance is implemented.

### BACKGROUND

Tax planning is often overlooked in people's lives. Most people do not consider tax implications until tax season approaches and income taxes must be filed. At that point, taxes for the previous year have already been paid.

Wealthy individuals who can afford a personal tax advisor can use tax planning to their advantage. For other individuals, ramifications of events that occur and actions taken during the year can have an impact on the individual's taxes that often do not become apparent until the individual's federal and state income tax returns are completed.

### SUMMARY

Embodiments of the disclosure are directed to a method for adjusting employee withholdings on an electronic computing device comprising: on the electronic computing device, receiving a tax strategy from an individual; obtaining initial tax information for the individual; using the initial tax information, calculate an initial income tax amount to be paid by the individual; determining an initial tax withholding allowance based on the initial income tax amount to comply with the tax strategy; receiving a notification of a tax event for the individual; when the notification of the tax event is received, automatically obtaining tax information related to the tax event; when the tax information related to the tax event is obtained, automatically using the tax information related to the tax event and the initial tax information to calculate a revised income tax amount; determining whether the revised income tax amount is consistent with the tax strategy; when a determination is made that the revised income tax amount is not consistent with the tax strategy: determining a revised tax withholding allowance based on the tax information related to the tax event and the revised income tax amount to comply with the tax strategy; and when the revised tax withholding allowance is different than the initial tax withholding allowance, implementing the revised tax withholding allowance.

In another aspect, a method for adjusting an income tax liability for an individual on an electronic computing device comprises: on the electronic computing device, receiving a tax goal for the individual; obtaining tax information for the individual; using the tax information, calculate an initial income tax amount to be paid by the individual; determining whether the initial income tax amount is consistent with the tax goal; when a determination is made that the initial income tax amount is not consistent with the tax goal: identifying a first action that would result in a revised income tax amount that is consistent with the tax goal; and implementing the first action; monitoring tax events for the individual during a calendar year; receiving information regarding a first tax event for the individual during the calendar year; when information is received regarding the first tax event, recalculate income taxes for the individual to obtain an updated income tax amount to be paid by the individual; determining whether the updated income tax amount is consistent with the tax goal; and when a determination is made that the updated income tax amount is not consistent with the tax goal: identifying a second action that would result in a revised updated income tax amount that is consistent with the tax goal; and implementing the second action.

In yet another aspect, an electronic computing device comprises: a processing unit; and system memory, the system memory including instructions which, when executed by the processing unit, cause the electronic computing device to: receive a tax strategy from an individual; obtain tax information for the individual; use the tax information, calculate an initial income tax amount to be paid by the individual; determine a first tax withholding allowance based on the initial income tax amount to comply with the tax strategy; receive notification of a tax event for the individual; using the tax information and information from the tax event, automatically calculate a revised income tax amount; determine whether the revised income tax amount is consistent with the tax strategy; when a determination is made that the revised income tax amount is not consistent with the tax strategy: determine whether an adjustment in the first tax withholding allowance could result in an income tax to be paid by the individual that is consistent with the tax strategy; when a determination is made that the adjustment in the first tax withholding allowance could be made: automatically calculate a second tax withholding allowance that would result in the income tax to be paid by the individual that is consistent with the tax strategy; and implement the second tax withholding allowance; and when a determination is made that the adjustment in the first tax withholding allowance would not result in the income tax to be paid by the individual that is consistent with the tax strategy: automatically determine an adjustment to an allocation percentage for future investments to be made by the individual during a calendar year that would result in the income tax to be paid by the individual that is consistent with the tax strategy, the allocation percentage specifying a percentage of taxable investments and a percentage of non-taxable investments; and make the adjustment to the allocation percentage for the future investments to be made by the individual during the calendar year.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports a personal tax advisor service.

FIG. 2 show example modules of the financial institution server computer of FIG. 1.

FIG. 3 shows an example method for implementing a personal tax advisor service.

FIG. 4 shows an example method for implementing an operation of FIG. 3 to determine whether a revised income tax amount is consistent with a tax goal.

FIG. 5 shows another example method for implementing a personal tax advisor service.

FIG. 6 shows example physical components of the financial institution server computer of FIG. 1.

### DETAILED DESCRIPTION

The present disclosure is directed to systems and methods for providing an automated personal tax advisor service for individuals.

Using the example systems and method, the personal tax advisor service can obtain information from the individual regarding a personal profile of the individual, sources of income, plans for expenses, known upcoming events and previous tax history. The personal tax advisor service can also obtain information from the individual during a calendar year regarding unexpected events, such as a new job, a bonus, a move to another state or country, etc. The personal tax advisor service can also obtain information from the individual regarding a tax strategy for the individual. Using the information received, the personal tax advisor service can automatically recommend and sometimes automatically implement one or more actions that can permit income taxes paid by the individual to be in compliance with the tax strategy.

As discussed in more detail later herein, some of the actions that can be implemented by the personal advisor service can include automatically adjusting the individual's withholding amount to be in compliance with the tax strategy and making one or more adjustments to current and future investments of the individual. One type of adjustment can be to change all or part of an asset from a taxable asset to a tax-free asset so that the tax strategy is met.

Different types of tax strategies are possible. Some individuals may prefer a tax strategy to minimize the individual's income tax. Some individuals may prefer a tax strategy to minimize an amount of out-of-pocket money needed to be paid when the individual's income taxes are filed. Some individuals may prefer a tax strategy that provides the individual with a refund of at least a certain dollar amount. Other tax strategies are possible.

In this disclosure, the individual is a customer of a financial institution, such as a bank and the personal tax advisor service is a service offered to the customer through the financial institution. The individual can communicate or develop the individual's tax strategy via meeting with an employee of the financial institution, by telephone or via selecting a tax strategy from a website of the financial institution.

The personal tax advisor service uses known information about the individual to calculate a preliminary income tax statement for the individual and to determine a tax withholding allowance or amount for the individual to permit the individual to be in compliance with the individual's tax strategy. The personal tax advisor service can receive information from the individual regarding unexpected events. In some cases, the personal tax advisor service can make use of a financial aggregator to learn about new events. As discussed in more detail later herein, the financial aggregator can obtain current information regarding the individual's financial accounts and provide the current information to the personal tax advisor service.

The systems and methods disclosed herein are directed to a computer technology that can identify a tax strategy for an individual, monitor tax events for the individual during a tax year and automatically take one or more actions when a tax event occurs to ensure that the individual stays compliant with the tax strategy. The systems and methods can automatically obtain information regarding income, expenses and life events for the user during the tax year, do preliminary income tax calculations using the information regarding income, expenses and life events and automatically determine which of the one or more actions can be used to stay compliant with the tax strategy.

The systems and methods can automatically determine and implement adjustments to one or more of the tax withholding allowance and an allocation percentage of taxable vs. non-taxable investments for each tax event that occurs during the tax year, when possible, that would permit the individual to stay compliant with the tax strategy. In addition, when it is no longer possible for the individual to stay compliant with the tax strategy by making adjustments to one or more of the tax withholding allowance and the allocation percentage, the systems and methods can recommend other actions, such as increasing charitable contributions, which could permit the individual to stay compliant with the tax strategy.

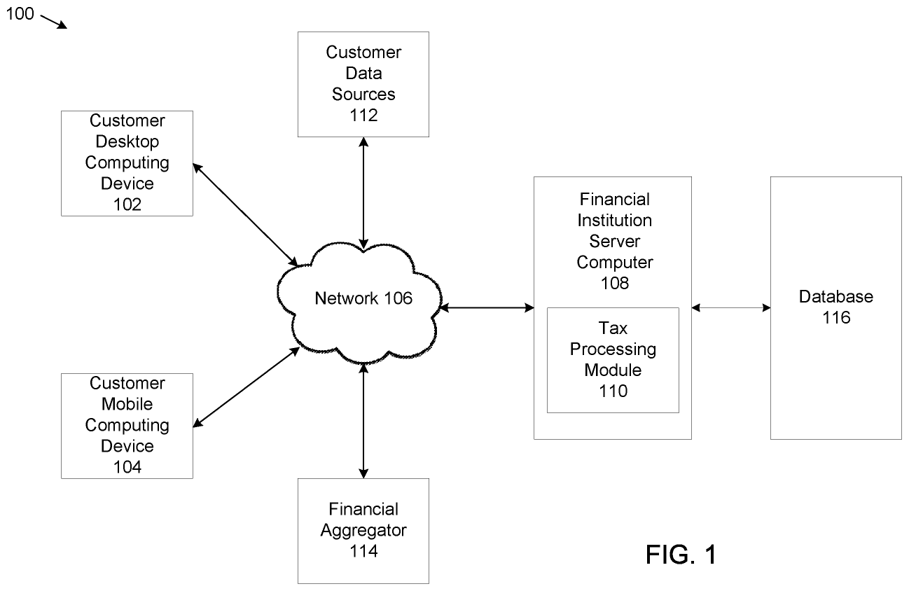

FIG. 1 shows an example system 100 that can support a personal tax advisor service for an individual. System 100 includes a customer desktop computing device 102, a customer mobile computing device 104, a network 106, a financial institution server computer 108, customer data sources 112, a financial aggregator 114 and a database 116. Financial institution server computer 108 includes a tax processing module 110. More, fewer or different components are possible. The individual is a customer of a financial institution associated with financial institution server computer 108.

The example customer desktop computing device 102 is an electronic computing device of the customer. The customer can login to financial institution server computer 108 from customer desktop computing device 102 via network 106. When logged in, the customer can access the customer's financial accounts at the financial institution, provide information regarding a customer profile and participate in an online session with a representative of the financial institution, such as a personal banker, regarding the customer profile. Other functionality regarding customer desktop computing device 102 is possible.

The example customer mobile computing device 104 is a mobile electronic computing device of the customer, for example a smartphone. The customer can login to financial institution server computer 108 from the smartphone using a software application for the financial institution on the smartphone. When logged in, the customer can access the customer's financial accounts at the financial institution, provide information regarding a customer profile and participate in an online session with the representative regarding the customer profile. Other functionality regarding customer mobile computing device 104 is possible.

The example network 106 is a computer network such as the Internet. Customer desktop computing device 102, customer mobile computing device 104, customer data sources 112 and financial aggregator 114 can wirelessly connect to or otherwise access financial institution server computer 108 via network 106.

The example financial institution server computer 108 is a server computer of a financial institution such as a bank. Financial institution server computer 108 contains or has access to financial records of the customer, including customer personal information and information regarding customer accounts. Financial institution server computer 108 also includes tax processing module 110.

The example tax processing module 110 can make tax recommendations to help the customer achieve the customer's tax strategy. Tax processing module 110 receives information regarding a customer profile, including a tax strategy for the customer and also obtains information regarding customer income, expenses and life events. Tax processing module 110 uses this information to calculate federal and state income taxes for the customer. Based on the incomes taxes calculated, tax processing module 110 can make recommendations regarding actions the customer can take so that the income taxes for the customer are consistent with the tax strategy. Some example recommendations can include changing tax withholding allowances for the customer and changing a balance between taxable and non-taxable assets for the customer. Other recommendations are possible. The tax processing module 110 is discussed in more detail later herein.

The example customer data sources 112 include sources of financial and other information regarding the customer not available at the financial institution. Example customer data sources can include other financial institutions, such as investment companies, real estate sources, business sources, social media sites, government organizations, credit card companies and other organizations that can provide income, expenses and other information regarding the customer. Other customer data sources are possible.

The example financial aggregator 114 includes data from one or more financial aggregators for the customer. As used in this disclosure, a financial aggregator is an independent organization that can compile financial information regarding the customer from different accounts, which can include bank accounts, credit card accounts, investment accounts and other business and consumer accounts in a single place. The financial aggregator 114 can be used in conjunction with or in lieu of customer data sources 112 to provide an up-to-date financial picture of the customer. In some implementations, customer data sources 112 can be used in lieu of financial aggregator 114.

The example database 116 is a database associated with the financial organization. Financial and other information regarding the customer can be stored in database 116.

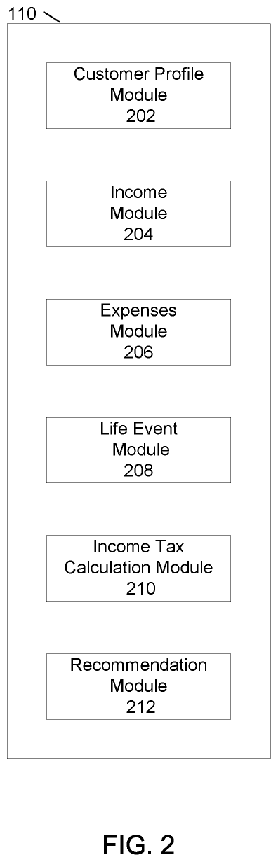

FIG. 2 shows example modules of tax processing module 110. The example modules include a customer profile module 202, an income module 204, an expenses module 206, a life event module 208, an income tax calculation module 210 and a recommendation module 212. More, fewer or different modules are possible.

The example customer profile module 202 processes profile information for the customer, which can include information about the customer and a tax strategy for the customer. Information about the customer can include such items as the customer name and related information, information regarding the customer's family, employer, current salary, residence, financial accounts at the financial institution and other similar information. Information about the tax strategy can include a summary of the tax strategy, when the tax strategy was created and when it was last updated.

The tax strategy for the customer can be developed solely by the customer or in consultation with a representative of the financial institution. The tax strategy can be entered online, via telephone or via a personal meeting with the customer at the financial institution. The tax strategy can comprise a tax goal for the customer. Example tax goals that can comprise the tax strategy can include a goal of minimizing a total amount of income tax paid during a calendar year, a goal of minimizing an out of pocket amount owed to the government at a time that the taxes are filed and a goal of receiving a refund of at least a minimum dollar amount. Other tax strategies are possible.

The example income module 204 processes information regarding income for the customer. In order to provide an accurate estimate of income tax to be paid by the customer, all sources of income for the customer need to be accounted for. The income module 204 obtains information from as many sources as needed to provide an accurate accounting of the customer's income. The income module 204 can obtain information regarding the customer's salary from the customer profile module 202. Information regarding the customer's investments and other sources of income can come from the customer profile module 202, customer data sources 112, financial aggregator 114 and from direct input from the customer.

The example expenses module 206 processes information regarding expenses for the customer. In order to provide an accurate estimate of income tax to be paid by the customer, all expenses that have an effect on the customer's taxes need to be accounted for. Expenses that can have a tax effect can include mortgage payments, real estate taxes, medical and dental expenses, business expenses, investment losses and charitable contributions. Other such expenses are possible. The expenses module 206 can obtain information regarding known or estimated expenses from the customer profile module 202, from customer data sources 112, from financial aggregator 114 and from direct input from the customer.

The example life event module 208 keeps track of events in the customer's life than can have an impact on the customer's taxes. In this disclosure, these events are known as tax events. The tax events are typically events that are unexpected and that typically cannot be estimated or predicted by any of the customer profile module 202, income module 204 or expenses module 206. Example tax events can include a marriage, a birth of a child, a death in the immediate family, unexpected medical expenses, an unexpected bonus or investment gain or loss, a job change, a salary increase, a purchase of a residential home, a purchase of a vacation home and a relocation to another state in the United States or another country which can have tax implications. Other tax events are possible.

The example income tax calculation module 210 calculates preliminary federal and state income taxes for the customer to attempt to determine a tax liability for the customer. In an example implementation, the income tax calculation module 210 can calculate the preliminary federal and state income taxes at a beginning of a calendar year and whenever the life event module 208 determines that a tax event has occurred. The income tax calculation module 210 uses income information from the income module 204, expenses information from the expenses module 206 and tax event information from the life event module 208 to calculate the preliminary federal and state income taxes. In addition, after a tax event occurs, the income tax calculation module 210 can automatically calculate revised federal and state income taxes for the customer based on updated tax event information from the life event module 208 and other modules. For example, if the tax event is a birth of a child, the updated tax event information can include an increase in the number of personal exemptions allowed for the customer and an estimate of tax deductible day care expenses for the child.

The example recommendation module 212 analyzes the preliminary federal and state income taxes and the tax strategy for the customer to determine what actions, if any, need to be taken in order for the customer's income tax to be consistent with the customer's tax strategy. For example, if the preliminary federal and state income taxes are too high based on the tax strategy, a recommendation could be to increase an investment amount that goes into a tax-free account or to shift funds allocated for a taxable account to a tax-free account. Another recommendation could include increasing an amount of charitable contributions. As another example, when the tax strategy is to obtain a refund of a certain dollar amount, a recommendation could be to decrease the tax withholding allowance for the customer so more income is withheld, which could result a larger refund amount.

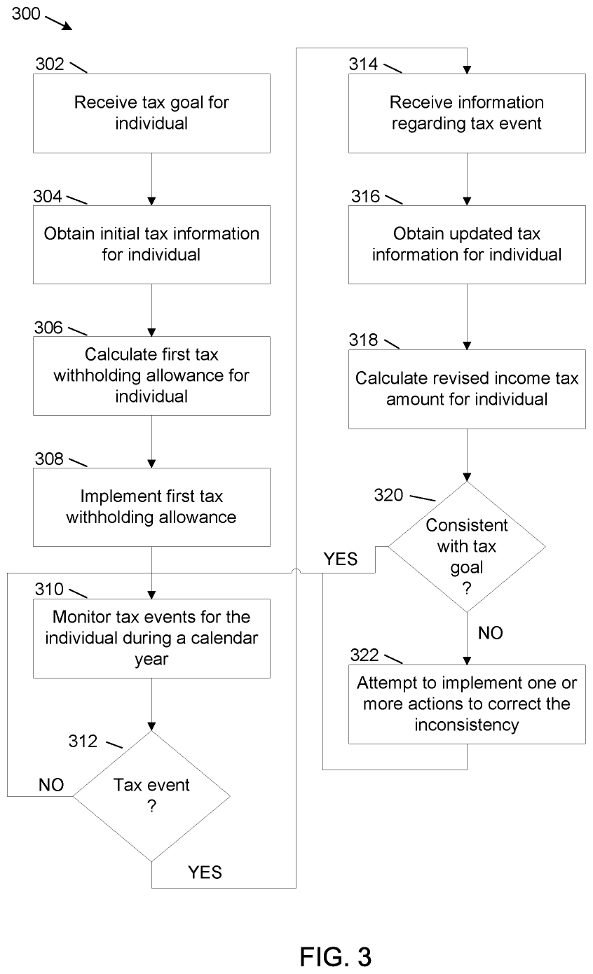

FIG. 3 shows a flowchart of an example method 300 for implementing a personal tax advisor service on a server computer. For method 300, the server computer is financial institution server computer 108.

At operation 302, a tax goal is received at the server computer. The tax goal is a specific goal, for example, minimizing out of pocket taxes to be paid when income taxes are filed, that can be consistent with a tax strategy for an individual who is a customer of a financial institution. For method 300, the financial institution is a bank and is associated with financial institution server computer 108.

In some examples, the tax goal can be entered into the server computer by the customer via a financial software application from the server computer that can be accessed on customer desktop computing device 102 or on customer mobile computing device 104. In other examples, the customer can meet in person, via telephone or via an online chat with a representative, such as a personal banker, of the financial institution. In these examples, the representative can enter the tax goal of the user into the server computer. Other examples are possible.

At operation 304, tax information is obtained for the individual. The tax information can already reside on the server computer or the tax information can be obtained from one or more external sources and entered into the server computer. The tax information can include such items a salary for the user and for the user's spouse, any additional sources of income for the user, expenses for the user such as mortgage payments, health care expenses, state and real estate taxes, charitable contributions and miscellaneous taxable expenses.

The one or more external sources for the tax information can include customer data sources and information from a financial aggregator for the user. The customer data sources, for example customer data sources 112, can include other financial institutions, such as investment companies, real estate sources, business sources, government organizations, credit card companies and organizations that can provide income, expenses and other information regarding the customer. The financial aggregator, for example financial aggregator 114, can be an independent organization that can compile financial information regarding the customer from different accounts, which can include bank accounts, credit card accounts, investment accounts and other business and consumer accounts in a single place.

At operation 306, a first income tax withholding allowance is calculated for the customer. The first tax withholding allowance is a preliminary income tax amount that can be calculated early in a tax year when income and expense information is available for the customer. Income taxes for the tax year are typically not due until April 15 of the following year. However, some individuals are required to pay estimated taxes that are due in quarterly payments during the tax year.

At operation 308, the first tax withholding allowance for the customer is calculated and implemented. The first tax withholding allowance is typically calculated by having the customer fill out a W-4 form. The W-4 form provides guidance regarding allowances that can be taken by the customer. Typically, one allowance can be taken for the customer and for each dependent of the customer. Additional allowances can be taken if the customer has expenses that would permit the additional allowances to be taken. When calculating a number of allowances to take, the customer can attempt to take a number of allowances that can permit the customer to achieve a tax goal consistent with the customer's tax strategy and still be within a number of allowances that are legally permitted for the customer. In some implementations, when permission has been received by the customer, the tax processing module 110 can automatically calculate the tax withholding allowance. In some implementations, when permissions are given by the customer, the tax withholding allowance can be automatically submitted to the customer's employer.

At operation 310, tax events are monitored for the customer during the calendar year. The tax events are typically events that are unexpected and that typically cannot be anticipated or predicted. Example tax events can include a marriage, a death in the immediate family, unexpected medical expenses, an unexpected bonus or investment gain or loss, a job change, a salary increase, a purchase of a home, a purchase of a vacation home and a relocation to another state or country which can have tax implications.

At operation 312, a check is made to determine whether a tax event has occurred. In some cases, the server computer is notified when the tax event occurs. In other cases, the server computer can poll one or more of the customer data sources 112 and financial aggregator 114 periodically to check if a tax event has occurred.

At operation 312, when a determination is made that a tax event has not occurred, control returns to operation 310 to continue monitoring for tax events for the customer.

At operation 312, when a determination is made that a tax event has occurred, at operation 314, information is received regarding the tax event.

At operation 316, updated tax information is obtained for the individual. In an example implementation, the updated tax information is automatically received. The updated tax information can be automatically received from one or more of the customer data sources 112 and from financial aggregator 114. For example, tax processing module 110 can automatically receive information regarding the customer from social media sources and extract information related to taxes from the information received. Tax information that can be extracted can include such as items as information that the customer has received a salary increase, purchased a new home or has a new family member. When a financial aggregator such as financial aggregator 114 is used, the financial aggregator can be configured to have permissions to access one or more bank accounts, credit card accounts, investment accounts and other accounts of the customer and to compile financial information, including tax information from these accounts.

At operation 318, a revised income tax amount is calculated for the individual. In an example implementation, tax processing module 110 can include a software application that can automatically calculate the revised income tax amount. The revised income tax amount is calculated to take into effect a tax implication of the tax event. For example, when the tax event comprises an unexpected income increase for the customer, the income increase can increase the customer's tax liability. Similarly, when the tax event comprises an unexpected expense, for example an illness or accident that results in a large medical expense for the customer, the tax event can decrease the customer's tax liability. An increase or decrease in the customer's tax liability can affect the tax goal of the customer.

At operation 320, a determination is made as to whether the revised income tax amount is consistent with the tax goal for the customer.

At operation 320, when a determination is made that the revised income tax amount is consistent with the tax goal for the customer, control returns to operation 310 to continue monitoring for tax events for the customer.

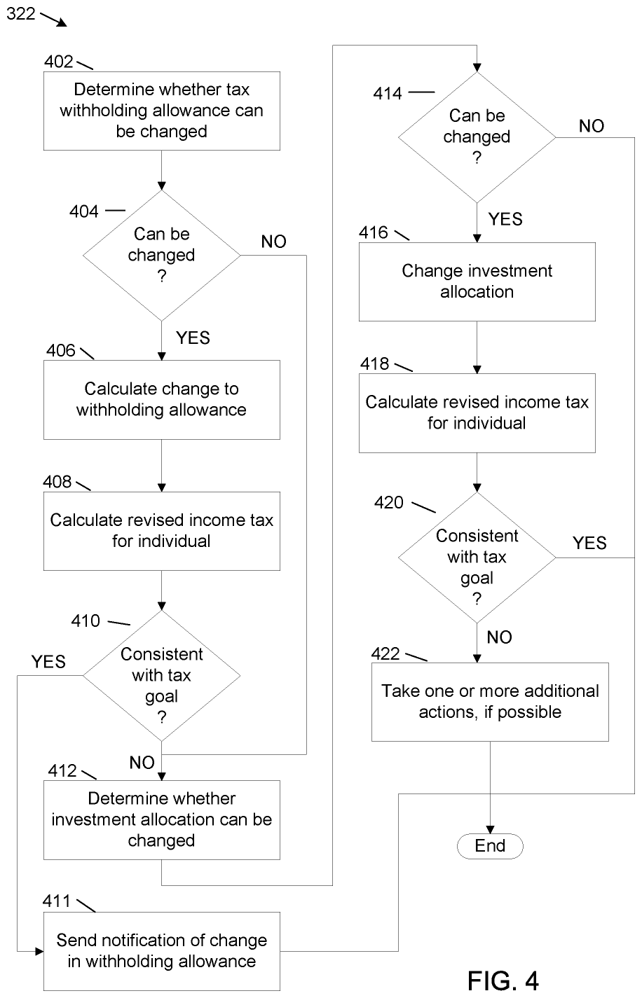

At operation 320, when a determination is made that the revised income tax amount is not consistent with the tax goal for the customer, at operation 322 an attempt is made to implement one or more actions that could be taken to correct the inconsistency with the tax goal. Details for operation 322 are discussed next herein with regard to FIG. 4. When operation 322 is completed, control returns to operation 310 to continue monitoring for tax events for the customer.

FIG. 4 shows a flowchart of an example method 400 for implementing operation 322 of FIG. 3 regarding attempting to implement one or more actions to correct the inconsistency with the tax goal. In an example implementation, some of the following operations can be automated so that any adjustments based on the actions can be automatically made, as explained further later herein.

At operation 402, a determination is made as to whether the tax withholding allowance for the individual can be changed. Government rules determine how many tax withholding allowances can be taken by an individual. Based on the tax goal of the individual, it is possible that the maximum number of tax withholding allowances for the customer may have already been taken at operation 308. It is also possible that based on the tax goal, fewer allowances that are permitted were taken at operation 308. For example, if the tax goal for the customer is to obtain a refund of a certain minimum amount, less tax withholding allowances may have been taken by the customer so that more of the customer's income would be withheld, resulting in a tax refund.

In addition, when the tax event comprises an unexpected large expense for the customer, such as a large medical expense that could result in a high medical expense deduction on the customer's income tax, the customer may be able to take one or more additional tax withholding allowances to offset the medical expense deduction.

At operation 404, when a determination is made that the tax withholding allowance cannot be changed, control advances to operation 412, as discussed later herein.

At operation 404, when a determination is made that the tax withholding allowance can be changed, at operation 406, an updated tax withholding allowance for the customer is calculated in an attempt to be consistent the tax goal for the customer.

At operation 408, a revised income tax for the customer is calculated based on changes to income or expenses from the tax event and based on the updated tax withholding allowance. The revised income tax can automatically calculated using income tax calculation module 210.

At operation 410, a determination is made as to whether the revised income tax is consistent with the tax goal for the customer.

At operation 410, when a determination is made that the revised income tax is consistent with the tax goal for the customer, at operation 411, a notification is sent regarding the change in tax withholding allowance and operation 320 ends. In some implementations, the notification is sent to the customer. The customer then fills out a revised W-4 form and submits the revised W-4 form to the customer's employer. In other implementations, when permissions have been previously received from the customer, financial institution server computer 108 can send a notification of the change in the tax withholding allowance directly to the customer's employer.

At operation 410, when a determination is made that the revised income tax is not consistent with the tax goal, at operation 412 a determination is made whether an investment allocation for the customer can be changed. When the customer has an investment program and is scheduled to periodically purchase financial assets during the year, a way that the investment program is implemented can have an impact on the customer's taxes.

For example, purchases of tax-free investments, such as individual retirement accounts, 401K plans, and certain non-retirement investments such as tax-free municipal bonds can permit the customer to subtract those purchases from income and thereby reduce taxable income and tax liability for the customer. The customer may be able to change an allocation percentage between taxable and tax-free investments during a calendar year to increase or decrease the customer's tax liability during the calendar year and thereby be more consistent with the tax goal for the customer.

At operation 414, a determination is made as to whether the investment allocation can be changed. In some cases, the investment allocation cannot be changed, for example when the tax event occurs toward the end to the calendar year and the customer does not have plans for any additional investments during the year. It is also possible that a determination can be made that any change in the investment allocation would have a minimal impact on the customer's tax liability. It is also possible that the customer has provided a directive not to change the investment allocation.

At operation 414, when a determination is made that the investment allocation cannot be changed or that the customer does not want the investment allocation to be changed, operation 320 ends.

At operation 414, when a determination is made that the investment allocation can be changed, at operation 416 a change is made to the investment allocation. In some implementations, the change to the investment allocation is made automatically, per an authorization previously obtained from the customer. In other implementations, the tax processing module 110 determines a change in the investment allocation and sends the customer a proposal to change the investment allocation in a specific way. In this implementation, the investment allocation isn't changed until permission is received from the customer.

At operation 418, a revised income tax for the individual is calculated. In an example implementation, the revised income tax is automatically calculated. The revised income tax calculation takes into effect the change of the investment allocation, the tax event and any previous changes to the withholding amount for the customer.

At operation 420, when the revised income tax calculation is consistent with the tax goal, operation 322 ends.

At operation 420, when the revised income tax calculation is not consistent with the tax goal, at operation 422, one or more additional actions are implemented, if possible. The one or more additional actions can include a further adjustment in the tax withholding allowance, a further adjustment in the investment allocation after the further adjustment in the tax withholding allowance is made, or another action. The another action can comprise such things as increasing an amount of investments during the calendar year, refinancing a mortgage, purchasing a vacation home and obtaining a new mortgage for the vacation home, increasing an amount of charitable contributions and any other action that can increase or reduce the income tax liability for the customer. Whether the action is needed to increase or reduce the income tax liability is dependent on whether the customer's income tax liability needs to be increased or decreased in order to be consistent with the tax goal for the customer.

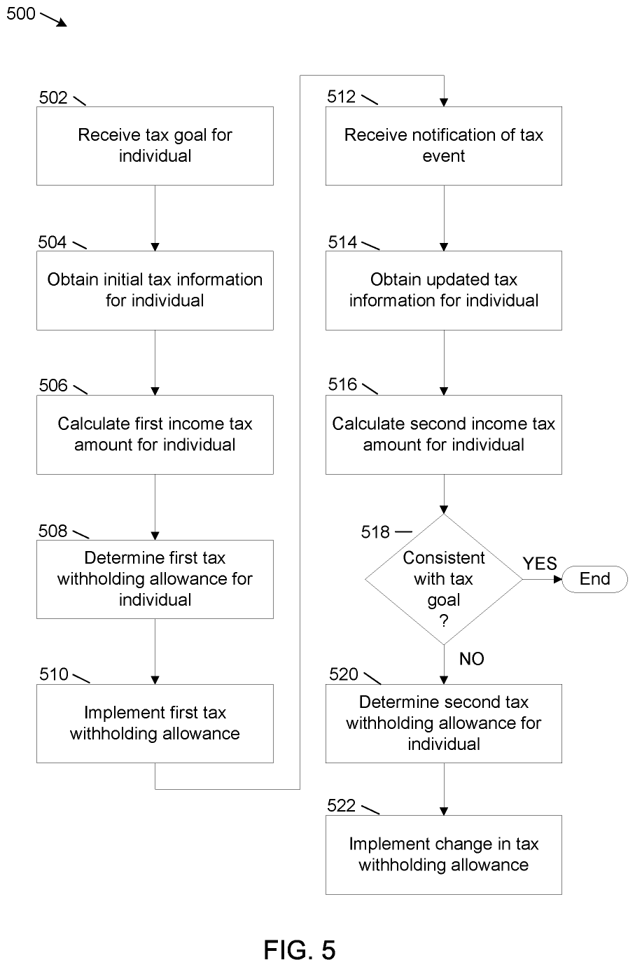

FIG. 5 shows a flowchart of an example method 500 for a specific implementation of the personal tax advisor service involving tax withholding allowances. In the example method 500, all of the following operations can be automated, as discussed earlier herein, so that changes to the tax withholding allowances can be automatically made.

At operation 502, a tax goal is received at the server computer. The tax goal is a specific goal, for example, minimizing out of pocket taxes to be paid when income taxes are filed, that can be consistent with a tax strategy for an individual who is a customer of a financial institution. For method 500, the financial institution is a bank and is associated with financial institution server computer 108.

At operation 504, tax information is obtained for the individual. The tax information can already reside on the server computer or the tax information can be obtained from one or more external sources and entered into the server computer. The tax information can include such items a salary for the user and for the user's spouse, any additional sources of income for the user, expenses for the user such as mortgage payments, health care expenses, state and real estate taxes, charitable contributions and miscellaneous taxable expenses. The one or more external sources for the tax information can include customer data sources and information from a financial aggregator for the user. The customer data sources can include other financial institutions, such as investment companies, real estate sources, business sources, government organizations, credit card companies and organizations that can provide income, expenses and other information regarding the customer. The financial aggregator can be an independent organization that can compile financial information regarding the customer from different accounts, which can include bank accounts, credit card accounts, investment accounts and other business and consumer accounts in a single place.

At operation 506, a first income tax amount is calculated for the customer. The first income tax amount is a preliminary income tax amount that can be calculated earlier in a tax year when income and expense information is available for the customer. Income taxes for the tax year are typically not due until April 15 of the following year. However, some individuals are required to pay estimated taxes that are due in quarterly payments during the tax year.

At operation 508, a first tax withholding allowance for the customer is calculated. The first tax withholding allowance is typically calculated by filling out a W-4 form. The W-4 form provides guidance regarding allowances that can be taken by the customer. Typically, one allowance can be taken for the customer and for each dependent of the customer. Additional allowances can be taken if the customer has expenses that would permit the additional allowances to be taken. When calculating a number of allowances to take, the customer can attempt to take a number of allowances that can permit the customer to achieve a tax goal consistent with the customer's tax strategy and still be within a number of allowances that are legally permitted for the customer.

At operation 510, the customer's tax withholding allowance is changed to the first tax withholding allowance.

At operation 512, the customer receives a notification of a tax event. For operation 510, the notification indicates that the customer has received an unexpected bonus as a reward for outstanding work performed by the customer.

At operation 514, updated tax information is obtained for the individual. In an example implementation, the updated tax information is automatically received. The updated tax information can be automatically received from one or more of the customer data sources 112 and from financial aggregator 114, as discussed earlier herein.

At operation 516, a second income tax amount is calculated for the customer. The second income tax amount takes into effect the added income that resulted from the bonus.

At operation 518, a determination is made as to whether the second income tax amount is consistent with the tax goal of the customer. If the bonus was small enough, the added income from the bonus may not have had a significant effect on the tax goal. However, for this example, the tax goal is large enough to have a significant effect on the tax goal, meaning that if an action isn't taken the tax goal will not be met.

At operation 518, when the second tax amount is consistent with the tax goal, method 500 ends.

At operation 518, when the second tax amount is not consistent with the tax goal, which is the case in this example, at operation 520, a second tax withholding allowance is determined for the customer. In the example of method 500, the tax goal is to receive a tax refund of a minimum amount when taxes are to be paid. Because the bonus caused an increase in income that resulted in a higher income tax for the customer than previously indicated, an action needs to be taken so that the customer still receives the refund of the minimum amount. In this case, the customer is able to reduce the tax withholding allowance, for example to take a tax withholding allowance of zero dependents.

Because the withhold allowance is lowered, more of the customer's income is withheld from each paycheck. Then, in spite of the fact that the customer's income increased, because more of the customer's income is being withheld, the customer will still receive the tax refund of at least the minimum amount.

At operation 522, the second tax withholding allowance is implemented and the customer's withholding is changed to the second tax withholding allowance.

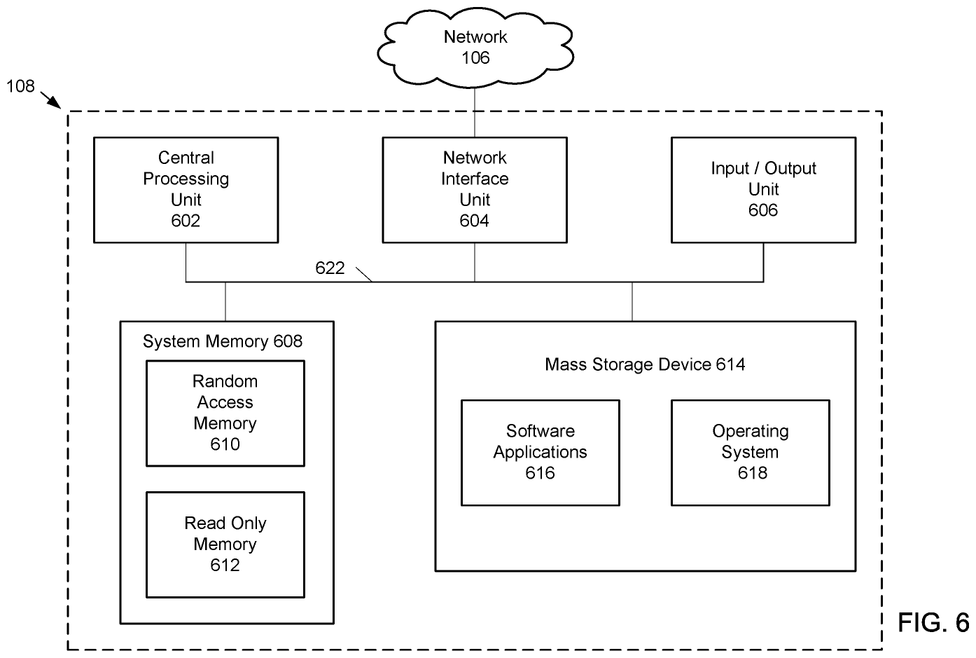

As illustrated in the example of FIG. 6, financial institution server computer 108 includes at least one central processing unit (“CPU”) 602, also referred to as a processor, a system memory 608, and a system bus 622 that couples the system memory 608 to the CPU 602. The system memory 608 includes a random access memory (“RAM”) 610 and a read-only memory (“ROM”) 612. A basic input/output system that contains the basic routines that help to transfer information between elements within the financial institution server computer 108, such as during startup, is stored in the ROM 612. The financial institution server computer 108 further includes a mass storage device 614. The mass storage device 614 is able to store software instructions and data. Some or all of the components of the financial institution server computer 108 can also be included in customer desktop computing device 102 and customer mobile computing device 104.

The mass storage device 614 is connected to the CPU 602 through a mass storage controller (not shown) connected to the system bus 622. The mass storage device 614 and its associated computer-readable data storage media provide non-volatile, non-transitory storage for the financial institution server computer 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the financial institution server computer 108.

According to various embodiments of the invention, the financial institution server computer 108 may operate in a networked environment using logical connections to remote network devices through the network 106, such as a wireless network, the Internet, or another type of network. The financial institution server computer 108 may connect to the network 106 through a network interface unit 604 connected to the system bus 622. It should be appreciated that the network interface unit 604 may also be utilized to connect to other types of networks and remote computing systems. The financial institution server computer 108 also includes an input/output controller 606 for receiving and processing input from a number of other devices, including a touch user interface display screen, or another type of input device. Similarly, the input/output controller 606 may provide output to a touch user interface display screen or other type of output device.

As mentioned briefly above, the mass storage device 614 and the RAM 610 of the financial institution server computer 108 can store software instructions and data. The software instructions include an operating system 618 suitable for controlling the operation of the financial institution server computer 108. The mass storage device 614 and/or the RAM 610 also store software instructions and software applications 616, that when executed by the CPU 602, cause the financial institution server computer 108 to provide the functionality of the financial institution server computer 108 discussed in this document. For example, the mass storage device 614 and/or the RAM 610 can store software instructions that, when executed by the CPU 602, cause the financial institution server computer 108 to display received data on the display screen of the financial institution server computer 108.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method for adjusting employee withholdings on an electronic computing device, the method comprising:
on the electronic computing device, receiving a tax strategy from an individual;
obtaining initial tax information for the individual;
using the initial tax information, calculate an initial income tax amount to be paid by the individual;
determining an initial tax withholding allowance based on the initial income tax amount to comply with the tax strategy;
querying a financial aggregator to obtain financial information, the financial aggregator being programmed to access the financial information from a plurality of different financial entities, including at least two or more of a bank account, a credit account, and an investment account, wherein the financial aggregator is configured with permissions to access the financial information from the plurality of different financial entities and compile the financial information from the plurality of different financial entities;
receiving a notification of a tax event for the individual from the financial information from the financial aggregator;
when the notification of the tax event is received, automatically obtaining tax information related to the tax event;
when the tax information related to the tax event is obtained, automatically using the tax information related to the tax event and the initial tax information to calculate a revised income tax amount;
determining whether the revised income tax amount is consistent with the tax strategy;
when a determination is made that the revised income tax amount is not consistent with the tax strategy:
determining a revised tax withholding allowance based on the tax information related to the tax event and the revised income tax amount to comply with the tax strategy; and
when the revised tax withholding allowance is different than the initial tax withholding allowance, determining whether the revised tax withholding allowance can be implemented;
upon determining that the revised tax withholding allowance can be implemented, implementing the revised tax withholding allowance;
upon determining that the revised tax withholding allowance cannot be implemented, automatically implementing a change to one or more of the individual's investment allocations based on previously obtained authorization from the individual that would result in the income tax amount to be paid by the individual that is consistent with the tax strategy.

2. The method of claim 1, wherein obtaining the initial tax information for the individual comprises obtaining, from the individual information needed to file taxes for the individual including family information, income information, investment information and expense information.

3. The method of claim 2, further comprising receiving updates to the initial tax information for the individual during a tax year.

4. (canceled)

5. The method of claim 1, wherein the tax event comprises one of an unexpected increase in income, an unexpected tax deduction, a change in home ownership, a change in a mortgage, a change in marital status, a birth of a child or a death of a family member.

6. The method of claim 1, wherein the tax event comprises moving to another state of the United States or to another country.

7. The method of claim 1, wherein the tax strategy comprises minimizing an amount of money owed by the individual at a time when taxes for the individual are filed.

8. The method of claim 1, wherein the tax strategy comprises receiving a tax refund of at least a minimum monetary amount.

9. The method of claim 1, further comprising periodically monitoring the individual's taxes during a calendar year and making additional adjustments in the individual's tax withholding allowance as necessary.

10. (canceled)

11. The method of claim 10, wherein the suggestions include whether one or more the investments should be a taxable investment or a non-taxable investment.

12. The method of claim 1, further comprising:
periodically determining a tax liability of the individual during a calendar year;
determining whether a tax withholding allowance for the individual is consistent with the tax strategy;
when a determination is made that the tax withholding allowance is not consistent with the tax strategy, automatically adjusting the tax withholding allowance for the individual to make the tax withholding allowance consistent with the tax strategy.

13-19. (canceled)

20. An electronic computing device comprising:
a processing unit; and
system memory, the system memory including instructions which, when executed by the processing unit, cause the electronic computing device to:
receive a tax strategy from an individual;
obtain tax information for the individual;
use the tax information to calculate an initial income tax amount to be paid by the individual;
determine a first tax withholding allowance based on the initial income tax amount to comply with the tax strategy;
query a financial aggregator to obtain financial information, the financial aggregator being programmed to access the financial information from a plurality of different financial entities, including at least two or more of a bank account, a credit account, and an investment account, wherein the financial aggregator is configured with permissions to access the financial information from the plurality of different financial entities and compile the financial information from the plurality of different financial entities;
receive notification of a tax event for the individual from the financial information from the financial aggregator;
using the tax information and information from the tax event, automatically calculate a revised income tax amount;
determine whether the revised income tax amount is consistent with the tax strategy;
when a determination is made that the revised income tax amount is not consistent with the tax strategy:
determine whether an adjustment in the first tax withholding allowance could result in an income tax to be paid by the individual that is consistent with the tax strategy;
when a determination is made that the adjustment in the first tax withholding allowance could be made:
automatically calculate a second tax withholding allowance that would result in the income tax to be paid by the individual that is consistent with the tax strategy; and
implement the second tax withholding allowance; and
when a determination is made that the adjustment in the first tax withholding allowance would not result in the income tax to be paid by the individual that is consistent with the tax strategy:
automatically determine an adjustment to an allocation percentage for future investments to be made by the individual during a calendar year that would result in the income tax to be paid by the individual that is consistent with the tax strategy, the allocation percentage specifying a percentage of taxable investments and a percentage of non-taxable investments; and
make the adjustment to the allocation percentage for the future investments to be made by the individual during the calendar year.
